(19) United States
(12) Patent Application Publication
(10) Pub. No.: US 2016/0167625 A1
(43) Pub. Date: Jun. 16, 2016

(54) SUPPORT FOR WINDSHIELD WASHER FLUID CONTAINER, WINDSHIELD WASHER FLUID CONTAINER, AND DEVICE COMPRISING SAID SUPPORT AND CONTAINER

(71) Applicant: VALEO SYSTÈMES D'ESSUYAGE, Le Mesnil Saint Denis (FR)

(72) Inventors: Gérald Caillot, Cernay La Ville (FR); Frédéric Giraud, Le Perray En Yvelines (FR); Marcel Trebouet, Chavenay (FR)

(73) Assignee: Valeo Systèmes d'Essuyage, Le Mesnil Saint Denis (FR)

(21) Appl. No.: 14/896,954

(22) PCT Filed: Jun. 13, 2014
(86) PCT No.: PCT/EP2014/062360

§ 371 Date: Dec. 9, 2015

(30) Foreign Application Priority Data
Jun. 14, 2013 (FR) 1355543

(51) Int. Cl. B60S 1/50; B60S 1/04

(52) U.S. Cl. CPC B60S 1/50; B60S 1/04

(57) ABSTRACT

The invention relates to a support (10) for a removable, interchangeable container for windshield washer fluid, said support (10) being designed to be secured to a vehicle and comprising a housing for one or more containers (30), which housing is designed to allow the repeated insertion and removal of the container(s) (30). The invention also relates to a removable, interchangeable container (30) for windshield washer fluid, designed to be mounted in such a support (10). The invention also relates to a device for supplying windshield washer fluid, comprising such a support (10) and such a container (30). The invention further relates to a vehicle windshield washing system comprising such a windshield washer fluid supply device.

The present invention consists in a support for a windshield washer fluid container, a windshield washer fluid container, a windshield washer fluid supply device and a vehicle windshield washer system.

Motor vehicles are routinely equipped with washer systems for cleaning the windshield of what could block the view of the passengers in the vehicle, such as mud splashes, insects, frost, ice. These washer systems are accompanied by windshield wiper systems and include a windshield washer fluid container installed on the vehicle and sprayer means enabling the liquid contained in the container to be sprayed in the direction of the windshield. For improved cleaning of the windshield, it is possible to add to the usual windshield washer fluid an additional product suited to the time of year and/or the required effect. For example, this product could improve the removal of insects in summer or de-icing of the windshield in winter. It is either added to the usual windshield washer mixture or contained in a second container and sprayed onto the windshield in combination with the windshield washer fluid.

Such systems are relatively inflexible and necessitate either a complex assembly with a plurality of pumps in the case of a plurality of containers or draining the container and replacing the liquid with an appropriate liquid and/or adding an additional product in the case of a single container.

Moreover, in the current systems, the fixing and the retention of a container are not suited to repeated fitting and removal thereof or to demounting of the support. The support is generally configured for one type of container and is not adapted to receive containers of varied shapes and/or volumes. Similarly, the current technology cannot show which type of fluid is being used.

An object of the present invention is to simplify the washer system, to improve the flexibility and the practicality thereof at the same time as improving the cleaning of the windshield. Generally speaking, it proposes an improvement to the current technology in this field. The invention further proposes to solve at least some of the problems mentioned above.

To this end, the invention consists in a support for a removable, interchangeable container for windshield washer fluid, said support being configured to be fixed to a vehicle and including a housing for one or more containers, said housing being configured to allow repeated fitting and extraction of said container or containers.

In other words, the support includes a housing into which a windshield washer fluid container can easily be fitted and from which the latter can be easily removed, in particular a pre-filled container. This easy fitting and removal of the container make it possible to be able to change the windshield washer fluid in a simple and practical manner as many times as necessary. The user can therefore adapt the windshield washer fluid according to their requirements, the season and/or the required effect.

In accordance with various embodiments of the invention, in combination or separately:

said housing is configured to enable said container or containers to be fixed by clipping,

said support includes means of connection to one of said containers enabling said container to communicate with a circuit of said fluid,

said connecting means are configured to enable opening of one of said containers,

said support includes means for fixing a pump for said fluid,

said connecting means include a pipe intended to connect said container and said pump,

said pipe includes a beveled end for opening said container or containers,

said support includes means for guiding the container or each container when it is mounted in the housing,

said guide means include a rectilinear slot or rib,

said guide means are located on lateral walls of said support.

The invention further concerns a removable and interchangeable container for windshield washer fluid, configured to be mounted in the support as described above.

In accordance with various embodiments of the invention, in combination or separately:

said container includes means for guiding the container or each container when it is mounted in the housing,

said guide means are translation guide means,

said guide means include a groove or a rectilinear rib,

said guide means are located on lateral walls of the container,

said container includes at least one opening, referred to as the first opening,

said first opening is adapted to cooperate with said connecting means,

said container is rigid and includes a second opening,

said second opening is adapted to maintain a pressure inside said container identical to atmospheric pressure,

said container is flexible and said first opening is the only opening of said container,

said container includes means for closing said openings,

said closure means are films,

said films are configured to close said openings after extraction of said container from said support,

said container is pre-filled with a windshield washer fluid,

said fluid is a de-icing liquid, a cleaning liquid or an anti-insect liquid,

said container comprises two independent compartments, and each of said compartments includes a first opening,

said first openings of said compartments are opposite one another.

The invention further concerns a windshield washer fluid supply device including a support and a container as described above. Said container is advantageously clipped into the housing or housings of said container.

In accordance with various embodiments of the invention, in combination or separately:

said device includes said pump,

said support and/or said container include container position poke yoke means, in particular making it possible to view the compartment intended to be used,

said support and/or said container include complementary guide means enabling the fitting of the container or containers in the housing,

the connecting means penetrate into said container or containers, in particular into said compartment.

In accordance with one aspect of the invention, which may be used with all or some of the above features, the support comprises reading means configured to detect identification means carried by the container or containers.

In accordance with various embodiments of the invention, in combination or separately:

said reading means are configured to detect the identification means with or without contact,

said reading means are configured to read the code of a transponder,

said support includes an electronic module housing the reading means.

Still in accordance with this aspect of the invention, the container includes identification means configured to be detected by reading means carried by the support.

In accordance with various embodiments of the invention, in combination or separately:

said identification means are configured to be detected by the identification means with or without contact,

said identification means include a transponder,

said identification means are covered or carried by a label,

said container includes on one of its walls a recess or a cavity for housing the identification means,

said container includes a label stuck to said wall and covering the recess.

This aspect of the invention further concerns a windshield washer fluid supply device including a support and a container as described above.

In accordance with various embodiments of the invention, in combination or separately:

said identification and reading means face each other in the position with the container mounted in the housing of the support,

in the position with the container mounted in the housing of the support said identification and reading means may be separated from each other by a wall of the container and/or a wail of the support.

In accordance with the aspect of the invention, the invention also concerns a vehicle including a vehicle windshield washer system as described and also, in the passenger compartment, means for displaying information relating to the container.

In accordance with this aspect of the invention, the invention finally concerns a method of controlling the windshield washer system of a vehicle as described including a step of identification of the container or containers in the housing of the support.

In accordance with various embodiments of this aspect of the invention, in combination or separately:

said method includes a step of transmitting information relating to the container to the passenger compartment of the vehicle,

said information transmitted includes one or more of the following: the type of fluid contained in the container, the level of fluid in the container, the quantity of fluid already used, and the benefit of using the fluid from the container for washing the windshield, etc.

In accordance with a further aspect of the invention that may be used with some or all of the above features, said container defines an internal enclosure connected to a fluid dispensing opening and includes at an end opposite the dispensing opening means for holding the container.

Said internal enclosure includes a first part, situated in the vicinity of the dispensing opening, that has a section different from that of a second part situated in the vicinity of the holding means.

In accordance with various embodiments of this aspect of the invention, in combination or separately:

said first part has a section larger than that of the second part so that the tank has a bulge at the level of this first part,

said first part has a section smaller than that of the second part so that the tank has a recess at the level of this first part,

said sections of the first and second parts each have a substantially rectangular shape,

said container has two substantially plane and parallel lateral walls connected at their rear ends to a substantially plane rear wall perpendicular to the lateral walls and at their front ends to a front wall that has an upper part and a lower part, the lower part of the front wall being substantially plane and parallel to the rear wall and connected to the upper part of the front wall by an inclined part,

said upper part of the front wall includes a depression or a cavity defining with the upper part of the container said holding means.

In accordance with this aspect of the invention, said support includes a housing for a container or containers as described above.

In accordance with various embodiments of this aspect of the invention, in combination or separately:

said housing is configured to receive containers the aforementioned first parts of the enclosures of which have different sections,

said housing is defined by two substantially parallel lateral walls of elongate shape the rear longitudinal edges of which are connected to one another by a rear wall substantially perpendicular to the lateral walls and the front longitudinal edges are free.

This aspect of the invention further concerns a windshield washer fluid supply device including a support and a container as described above.

In accordance with another aspect of the invention, which may be used with some or all of the above features, the invention also concerns a tank including a windshield washer fluid supply opening and a closing lid.

Said lid carries a projecting element substantially coaxial with the opening.

In accordance with various embodiments of this aspect of the invention, in combination or separately:

said projecting element is a finger,

said finger is substantially cylindrical,

said finger has a substantially pointed free end,

said finger is connected to the lid by webs of material each of which has a substantially radial orientation relative to the longitudinal axis of the finger,

said webs of material are regularly distributed around this axis,

at least a part of said projecting element passes through the opening,

said projecting element is formed in one piece with the lid,

said projecting element is added and fixed to the latter,

said lid includes means nesting over a part of the tank.

In accordance with this aspect of the invention, said support includes a housing for a container or containers as described above and further includes a tank as described above.

In accordance with various embodiments of this aspect of the invention, in combination or separately:

said opening of the tank opens into the housing of the container or containers,

said lid of the tank forms the base or lower part of the support.

This aspect of the invention further concerns a windshield washer fluid supply device including a support and a container as described above.

In accordance with various embodiments of this aspect of the invention, in combination or separately:

said container includes a fluid dispensing opening that is equipped with means of connection to the opening of the tank,

said connecting means are configured to be at least partly engaged in said opening,

said connecting means of the container include an element mobile from a first position blocking the opening of the container to a second position freeing that opening,

said projecting element of the tank of the support is configured to cooperate with and to move the mobile element from its first position to its second position when the connecting means are engaged in the opening of the tank,

said mobile element is a ball that is trapped in a housing of the connecting means,

said connecting means include a plug that is mounted in the opening of the container,

said plug is covered by a removable film.

In accordance with a further aspect of the invention, that may be used with some or all of the above features, said container includes at least one cavity configured to receive immobilizing or locking means carried by the support.

In accordance with various embodiments of this aspect of the invention, in combination or separately:

said cavity is situated on an upper part of the container,

said cavity is opposite a fluid dispensing opening of the container,

said cavity has a substantially parallelepipedal general shape,

said cavity is formed in an area connecting an upper wall of the container to a rear wall,

said cavity is delimited by two plane walls that are substantially perpendicular to each other.

In accordance with this aspect of the invention, said support includes a housing for a container or containers as described above.

Said support includes locking means configured to be at least in part engaged in the cavity of the container and to bear on a wall of that cavity with a view to immobilizing the container in said housing.

In accordance with various embodiments of this aspect of the invention, in combination or separately:

said locking means are of the elastic clipping type,

said locking means include at least one hook,

said hook is carried by an elastically deformable tongue,

said locking means are located on an upper part of the support.

This aspect of the invention further concerns a windshield washer fluid supply device including a support and a container as described above.

In accordance with various embodiments of this aspect of the invention, in combination or separately, said cavity of the container cooperates with said locking means of the support to immobilize the container in the housing of the support.

Finally, the invention concerns a vehicle windshield washer system including a windshield washer fluid supply device as described above, means for spraying the windshield with said fluid and means for wiping the windshield.

The invention will be better understood, and other objects, details, features and advantages thereof will become more clearly apparent in the course of the following detailed explanatory description of at least one embodiment of the invention given by way of purely illustrative and non-limiting example and with reference to the appended diagrammatic drawings.

In those drawings:

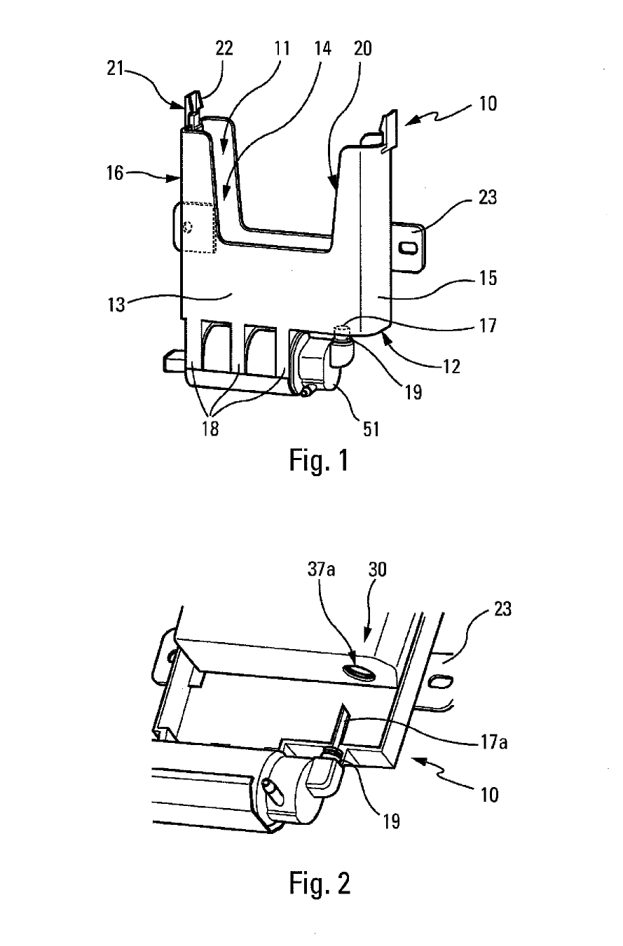

FIGS. 1 to 6 concern a first embodiment of the invention, in which:

FIG. 1 is a perspective view of a support in accordance with the invention,

FIG. 2 is a sectional perspective view of the bottom part of the support from FIG. 1, a container in accordance with the invention being in the process of being mounted or demounted,

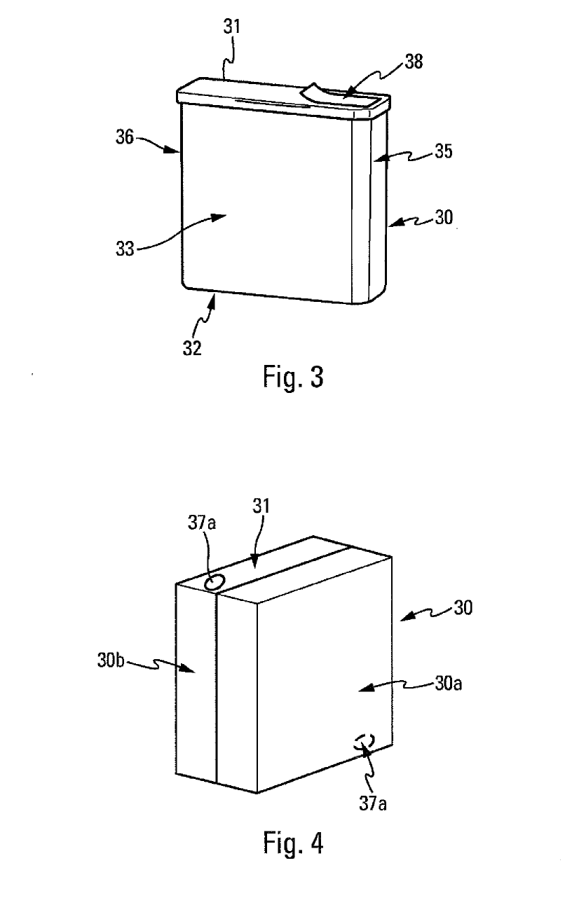

FIG. 3 is a perspective view of a container in accordance with the invention,

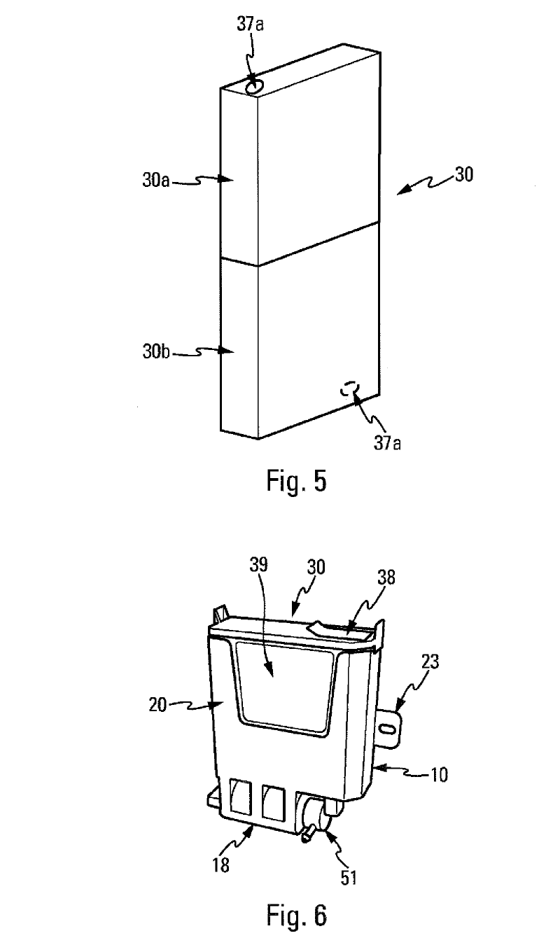

FIGS. 4 and 5 are diagrammatic perspective views of the container in accordance with two particular embodiments of the invention comprising two independent compartments,

FIG. 6 is a perspective view of a device in accordance with the invention in which poka yoke means are shown,

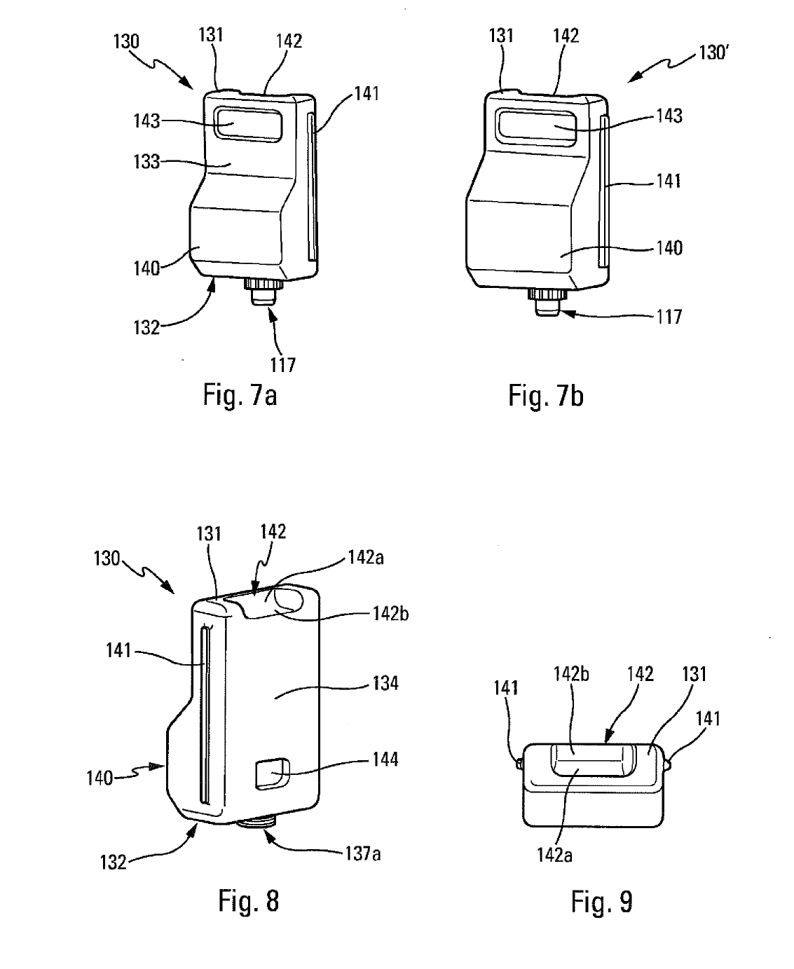

FIGS. 7 to 17 concern a second embodiment of the invention, in which:

FIGS. 7a and 7b are perspective views of two containers in accordance with the invention seen from the front and from the side,

FIG. 8 is a perspective view of the container from FIG. 7a seen from the rear and from the side,

FIG. 9 is a perspective view of the container from FIG. 7a seen from above,

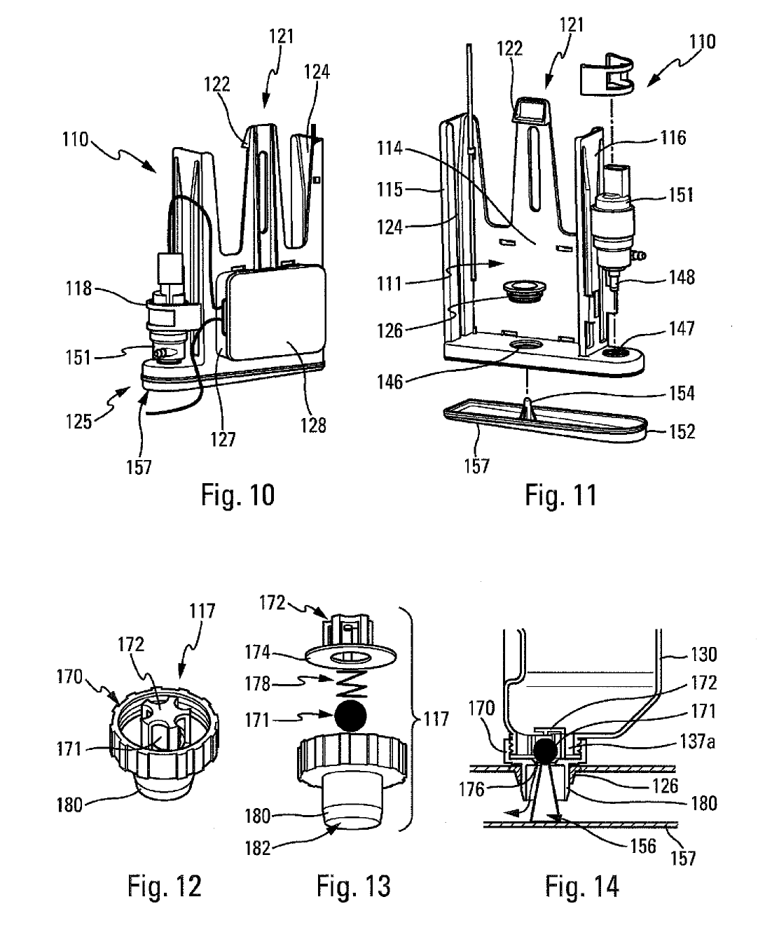

FIG. 10 is a perspective view of a support in accordance with the invention seen from the rear and from the side,

FIG. 11 is an exploded perspective view of the support from FIG. 10 seen from the front and from the side,

FIGS. 12 and 13 are perspective views of the means for connecting the container to the support from FIG. 10,

FIG. 14 is a sectional view of the connecting means from FIGS. 12 and 13,

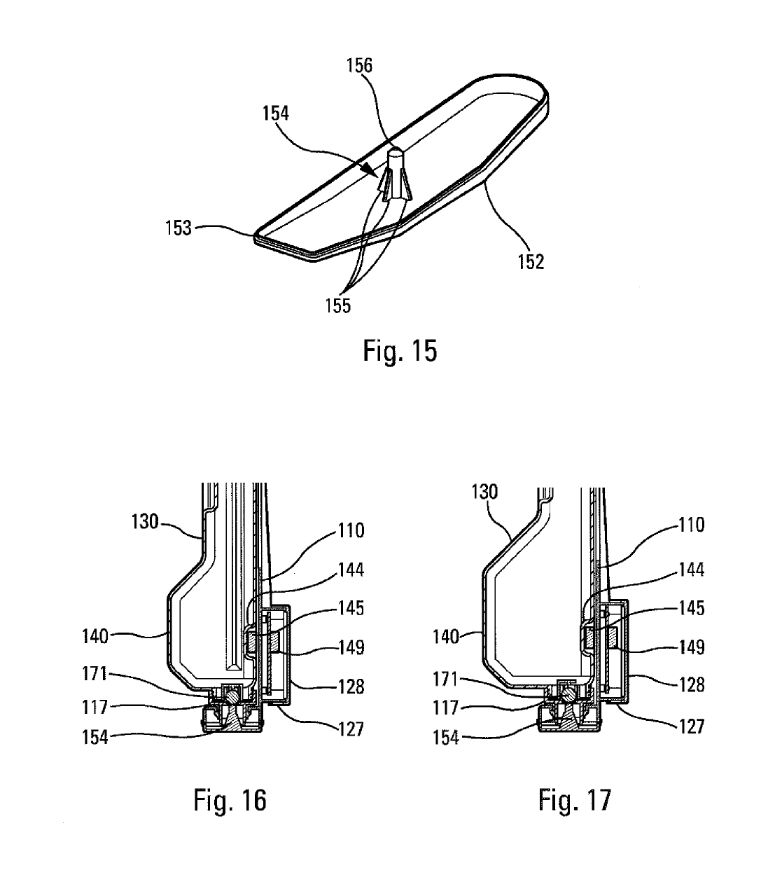

FIG. 15 is a perspective view of a base forming a lid of the support from FIG. 10,

FIGS. 16 and 17 are sectional views of a device in accordance with the invention and show identification and reading means,

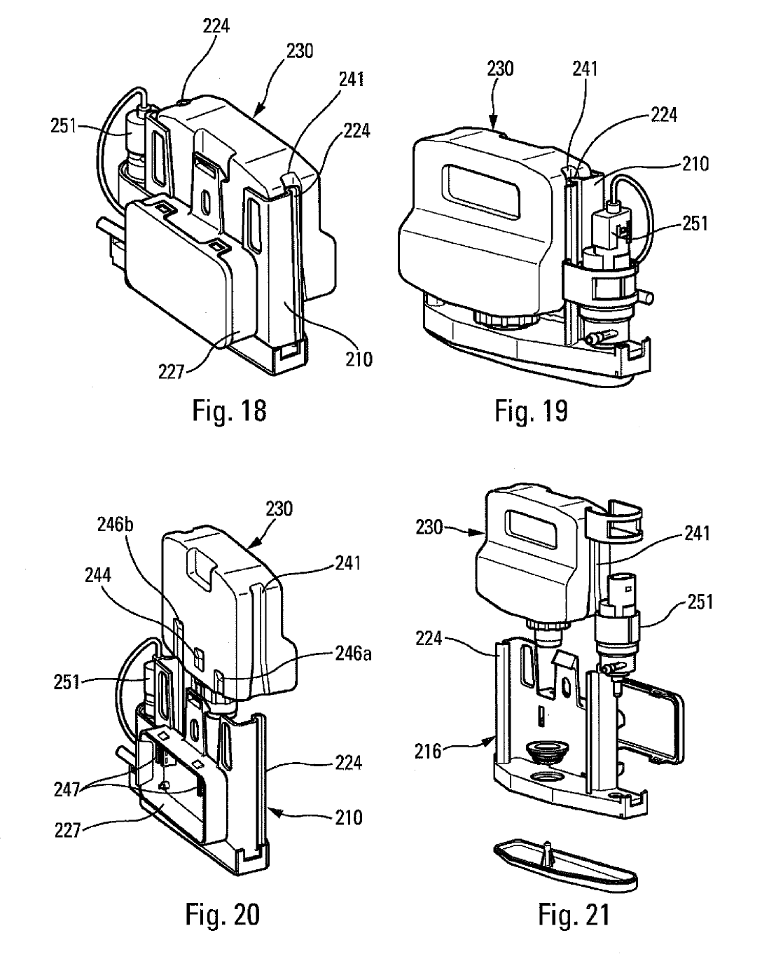

FIGS. 18 to 25 concern a third embodiment of the invention, in which:

FIG. 18 is a perspective view of a device in accordance with the invention seen from the rear and from the side,

FIG. 19 is a perspective view of the device from FIG. 18 seen from the front and from the side,

FIGS. 20 and 21 are other partly exploded perspective views of the device from FIG. 18,

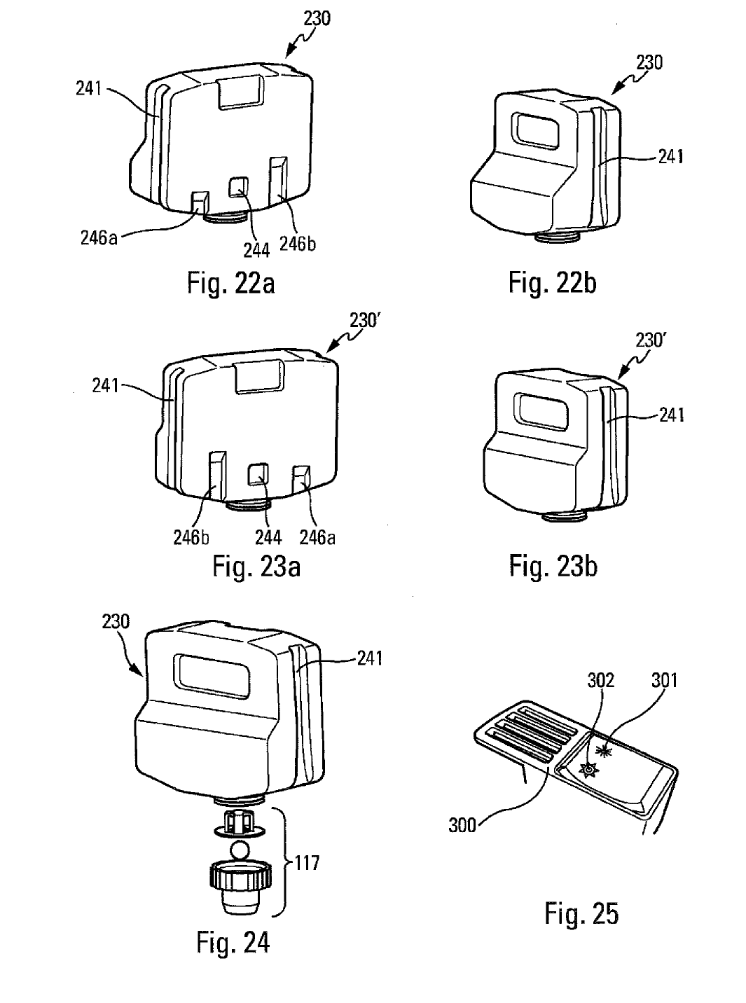

FIGS. 22a and 22b are perspective views of a container in accordance with the invention,

FIGS. 23a and 23b are perspective views of another container in accordance with the invention,

FIG. 24 is an exploded perspective view of a container and of its connecting means, and

FIG. 25 is a perspective view of display and activation means of the device in accordance with the invention located in the passenger compartment of a vehicle.

As shown in the various figures, the invention concerns first of all a support 10 for a windshield washer fluid container 30. Said support 10 is configured to be fixed to a vehicle. It includes a housing 11 that is configured to allow repetitive fitting and removal of said container or containers 30. The user can therefore change the container 30 as many times as required.

The housing shown in FIG. 1 is of parallelepiped shape; it may have any other shape provided that it is able to accommodate a container and that this shape is adapted to the shape of the container and to retaining it in the housing. It includes a lower wall 12, a front wall 13 and a rear wall 14 and two opposite sides 15 and 16, so as to form said housing 11. The front and rear walls 13, 14 and/or the opposite sides 15, 16 are integral with said rear wall 14. The opposite sides 15 and 16 connect the front and rear walls 13 and 14.

The front wall 13 and/or the rear wall 14 include a notch 20 allowing the container to be seen and/or allowing it to be manipulated.

The support 10 is configured to be fixed to the vehicle; here it is fixed by pierced flanges 23 situated on respective opposite sides of the support 10 and in the same plane as the rear wall 14 of the support. These fixing means are shown by way of illustration only. Any other means or any other location is possible.

Said support 10 could further include means for locking the container 30 in said housing 11, notably clipping means. Here said locking means include a flexible tongue 21 ending in a hook 22 integral with one and/or the other of the upper ends of said opposite sides 15, 16.

The lower wall 12 advantageously includes connecting means 17 that enable the connection between the container 30 and a windshield washer fluid circuit. The circuit includes a pump 51 and a set of pipes (not shown) connecting the pump 51 to the sprayer means. It is possible to connect the container 30 directly to the pump 51. In this case, the support 10 includes fixing means 18 for fixing the pump to the support. It is also possible for the container 30 to be connected to the circuit, in particular to said pump, by way of a pipe 19 of the connecting means 17.

The connecting means 17 may be configured to allow automatic opening of the container, such as by a beveled end 17a of said pipe 19 piercing of the bottom of the container.

As shown in the various FIGS. 1 to 6, the invention also concerns the windshield washer fluid container 30, configured so as to be mounted on the support 10 described above. It is removable and interchangeable. It can therefore be repeatedly fitted, removed and then replaced by another container 30 by the user as a function of their requirements and as many times as necessary.

The container 30 shown in FIG. 3 is of parallelepiped shape; it may have any other shape provided that the latter is adapted to the shape of the support 10 and the container can be inserted in the housing 11 of the latter. It includes an upper wall 31, a lower wall 32, a front wall 33, a rear wall 34 and two opposite sides 35 and 36.

The container 30 includes at least one opening 37. The opening 37 situated on the lower wall is referred to as the first opening 37a. This opening 37a is adapted to cooperate with the connecting means 17 situated on the support 10. This opening 37a allows dispensing of the windshield washer fluid to the circuit.

The container 30 may also include a second opening 37b situated on the upper wall 31 of the container 30. This serves to maintain a pressure inside the container 30 identical to atmospheric pressure. This second opening 37b may therefore be necessary in the case of a rigid container 30 to facilitate the windshield washer fluid leaving it. On the other hand, in the case of a flexible container 30, this second opening 37b is optional, the container being able to deform to allow the fluid to exit to the circuit. In the case of a flexible container 30, it is then possible to design a container with a single first opening 37a.

The openings 37a and 37b may include closure means 38. These may be films. These films will notably be configured to be able to close the openings 37, in particular the first opening 37a, after extracting the container 30 from the support 10. The containers extracted in this way can be reclosed for improved storage until the next use of the container, in particular if they are removed when not yet empty. This prevents deterioration or leaking of the windshield washer fluid.

By way of nonlimiting example, the closure means 38 may be chosen from stickers, membranes, plugs or flexible valves. In the case of a container 30 with a plurality of openings 37, the closure means 38 may be identical or a combination of the means listed above.

The container 30 in accordance with the invention is advantageously pre-filled with a windshield washer fluid. This may be a de-icing liquid, a cleaning liquid or an anti-insect liquid, for example. The user therefore chooses the liquid required to be able to clean their windshield effectively.

In accordance with one aspect of the invention, said container 30 is disposable after using the liquid. In other words, said container 30 is not intended to be refilled after the pre-filled quantity of liquid has been used up. It therefore includes either a single first opening 37a, serving to drain it, or first and second openings. In the case of the presence of a second opening 37b, for maintaining it at atmospheric pressure, this could be a simple vent orifice, of small diameter, too small to allow it to be refilled.

In one particular embodiment of the container 30, shown in FIGS. 4 and 5, the container comprises two independent compartments 30a and 30b. It is therefore possible to have two different windshield washer fluids, one of which is being used and other of which is ready for use. Each of the compartments includes at least one first opening 37a. The first openings 37a are preferably opposite one another so that the fluid ready for use does not weigh on the first opening 37a of the corresponding compartment.

FIG. 6 shows the device in accordance with the invention comprising a support 10, a container 30 and a pump 51. The front wall 13 of the support 10 and the front wall 33 of the container 30 include poka yoke means 20 and 39. As shown, the poka yoke means 20 of the front wall 13 may notably take the form of a notch configured so that the poka yoke means of the container 39, here a sticker of a particular color with a text and a diagram that are representative, can be seen, in particular through said notch 20. By way of nonlimiting example, the poka yoke means of the container 30 may be a particular shape, a label, a sticker, a text, a diagram or a color. The user can therefore easily visualize the type of fluid contained in the container/the compartment being used.

Obviously any other poka yoke means may be envisaged, such as complementary shapes of the support and the container, respectively, intended to nest one in the other when the appropriate container is mounted on the support.

Note that variant embodiments are of course possible. It is notably possible, in an additional embodiment, for the housing 11 to be adapted to receive a container with double compartments 30a and 30b. In this embodiment, the housing 11 will be of a size and a shape adapted to the container and will include connecting means for putting the compartment being used in communication with the windshield washer fluid circuit. The poka yoke means 20 and 39, if any, will make it possible to render the compartment being used visible.

In a variant embodiment shown in FIGS. 7 to 17, the support 110 includes a housing 111 formed of a lower wall, a rear wall 114 and two opposite sides 115 and 116. In this variant, the support 110 does not include a front wall, which makes it possible to mount a number of types of container 130 in the housing 111 and in particular containers having different internal volumes and shapes.

FIGS. 7a, 8 and 9 show a container 130 of one type and FIG. 7b shows container 130′ of another type, the capacities and the shapes of these containers 130, 130′ being different.

Each container 130, 130′ includes an upper wall 131, a lower wall 132, a front wall 133, a rear wall 134 and two opposite sides.

The container 130 includes at least one opening, referred to as the first opening 137a, situated on the lower wall 132. The latter opening is intended to be equipped with means 117 for connection to the support 110. The opening 137a enables the windshield washer fluid or washer fluid to be dispensed to the circuit. The opening 137a may include closure means such as a film, in particular when the container 130 has not yet been used. This film is intended to be pierced when placing the container 130 on the support 110, for example.

The container 130, 130′ further includes a bulge or swelling 140 for adjusting its capacity. Here this swelling 140 is located in the lower part of the container 130. To be more precise, the front wall 133 of the container includes a lower part and an upper part that are substantially parallel and that are joined to each other by an inclined part, the lower part being in front of the upper part. Because of this swelling 140, the internal enclosure defined by the container does not have the same section in the lower part and in the upper part. The larger the swelling of the container the greater the capacity of the container. The container 130′ in FIG. 7b has a swelling larger than that 130 in FIG. 7a and therefore has a greater capacity (internal volume of 1.5 l for the container 130′ compared to 1.2 l for the container 130). The swelling 140 can vary as a function of the type of fluid contained. Thus for a fluid that is used a lot and/or necessitates a greater quantity of product to be effective, such as a de-icing liquid, the swelling 140 will be larger than for a fluid used less and/or necessitating a smaller quantity, such as an anti-insect liquid. The size difference also makes it possible to distinguish the types of liquid and to tell the type of liquid being used.

In another variant embodiment, not shown, at least one of the containers may include a recess instead of a bulge. This is the case if the fluid contained in the container is used in very small quantities, for example, and a container of small capacity is sufficient for that fluid.

The container 130 can also include guide means 141 intended to cooperate with complementary guide means 124 of the support. Here the guide means 141 include rectilinear parallel ribs located on the sides of the container 130, over substantially all the height thereof. Such ribs form guide rails.

The container 130 can also include a depression or a cavity, referred to as the first cavity 142, located in the area joining the upper wall 131 and the rear wall 134 of the container. Here this is a cavity of substantially parallelepipedal shape, which is configured to cooperate with locking means 122 of the support 110 that are described in more detail hereinafter. The cavity 142 has a width or transverse dimension less than that of the container 130 and is formed substantially in the middle of the aforementioned connecting area. Here the cavity 142 is delimited by two substantially perpendicular walls, a vertical wall 142a and a horizontal wall 142b, the lower edge of the vertical wall 142a being joined to the front edge of the horizontal wall 142b.

The container 130 can also include a depression or cavity, referred to as the second cavity 143, on the upper part of the front wall 133. Here this is a substantially parallelepipedal cavity. It has a width or transverse dimension less than that of the container and is formed substantially in the middle of the front wall 133. This second cavity 143, and where applicable the first cavity 142, form means for holding the container 130 when mounting and/or demounting it. The size of the two cavities will advantageously be sufficient for the user to be able to place the fingers of one hand therein for mounting and/or demounting the container 130. The holding means of the container are therefore situated at the end of the container opposite its opening 137a.

The container 130 can also include one or more cavities on the lower part of the rear wall 134, referred to as the third cavity 144, as shown in FIG. 8. Here the container includes a single third cavity 144 smaller than the other cavities 142, 143 that is configured to accommodate means 145 for identification of the container, as described in more detail hereinafter.

To insert the container 130 and to retain it in complete safety in the housing 111 of the support 110, the support 110 includes locking means 121, 122 and guide means 124. The locking means include a flexible tongue 121 terminated by a hook 122, this tongue 121 extending upward from the rear wall 114 of the support 110, substantially in line with that wall. The hook 122 is adapted to cooperate with the horizontal wall 142b of the first cavity 142 of the container.

The hook 122 locates in the cavity 142 and bears on the horizontal wall 142b thereof, thus preventing any movement of the container 130. This guarantees correct positioning of the container 130 and a good seal at the level of the connecting means 117 between the container and the support through the application of a slight force to the container by the hook. Moreover, the first cavity 142 also makes it possible to place the hook 122 lower down than if it had to be positioned directly on the upper wall 131 of the container 130. The hook 122 therefore does not exceed much if at all the height of the container 130, which prevents the hook from being in the way and therefore facilitates the accommodation and fixing of the support 110 in the vehicle. The location of the first cavity 142 is advantageously dependent on the location of the locking means. It is also possible to have a plurality of cavities 142 as a function of the number of locking means.

Alternatively, the locking means 121, 122 can be adjustable so as to adapt to different sizes and notably different heights of the container.

The guide means 124 of the support 110 are configured to cooperate with the complementary guide means 141 of the container 130. Here the guide means 124 of the support 110 are grooves formed on the sides 115, 116 of the support 110, these grooves being substantially rectilinear and having a substantially vertical orientation in the position of use of the support. As explained above, the guide means 141 of the container include complementary ribs (FIGS. 7a to 9).

The support 110 can also include means 118 for fixing a pump 151 to the support 110. In the example shown, the pump 151 is fixed to one side 116 of the support 110 by means of a ring that surrounds the pump and is removably fixed by appropriate means, such as hooks, to complementary means on the side of the support 110.

The support 110 includes a base 125 that includes an internal tank 157, this tank being closed and sealed by a lid 152 that is fixed by nesting means 153 to the upper part of the base 125. The tank 157 is intended to be fed with fluid by the container 130 and to dispense the fluid to the pump 151. The tank 157 is therefore in fluid communication with the container and the pump. First connecting means 117 are provided between the dispensing opening 137a of the container 130 and a supply opening 146 of the tank 157 and second connecting means 148 are provided between a dispensing opening 147 of the tank and an inlet of the pump 151 (FIG. 11).

To provide the seal between the connecting means 117 and the tank 157, a seal 126 is mounted in the opening 146 of the tank and is intended to be slightly compressed between the tank and the connecting means 117. Another seal can be mounted in the opening 147 of the tank intended to be connected to the inlet of the pump 151.

In the example shown, the connecting means 117 include a plug 170 that is fixed to a neck of the container 130, at the level of its opening 137a, for example by screwing it thereto. The plug 170 may be permanently fixed to the container. The plug includes a mobile element, here a ball 171, that is trapped in a housing, here a cage 172 of the plug 170.

The plug 170 includes a transverse wall 174 carrying the cage 172 and including a central orifice 176, this central orifice having a diameter less than that of the ball 171 and being conformed to form a seat for that ball 171. The ball 171 is movable inside its cage 172 between a position in which it bears on the seat and blocks the orifice 176 and a position in which it is at a distance from the seat and therefore leaves the orifice 176 free, which orifice then communicates with the opening 137a of the container 130. Return means such as a spring 178 are mounted in the cage 172 and urge the ball 171 into the position blocking the orifice 176.

The plug 170 further includes a cylindrical rim 180 nesting in the opening 146 of the tank 157. As shown diagrammatically in FIG. 14, the lid 152 of the tank carries a projecting element 154 which here is a finger or a striker 156 that is intended to bear on the ball 171 and to move it during the aforementioned nesting. In the nested position, the striker 156 is engaged in the rim 180 and its free end bears on the ball 171 and moves it away from its seat. The fluid contained in the container 130 can then pass through the orifice 176 of the plug into the tank 157 (FIG. 14).

The striker 156 is seen better in FIG. 15. It has a cylindrical general shape the free upper end of which is substantially pointed. It is joined to the lid 152 by webs 155 of material each of which has a substantially radial orientation relative to the longitudinal axis of the finger and that are regularly distributed around that axis. These webs 155 form blades intended to slit the aforementioned film 182 that can cover the free end of the cylindrical rim 180 of the plug 170 when mounting the container on the support (FIG. 13). Here there are four of these webs. The striker 156 can be in one piece with the lid 152 or a piece added and fixed to the lid.

A single movement in translation of the container 130 relative to the reservoir 157, until the plug 170 nests in the opening 146 of the tank, is sufficient to establish fluid communication between the container and the tank.

FIGS. 16 and 17 show the identification means 145 carried by the container 130 and referred to above. These identification means 145 notably enable a management system (not shown) to tell the type of washer fluid being used. They can also be connected to the washer fluid circuit, in particular to the pump 151, for example to detect the number of cycles of use and to determine whether the container 130 is empty and must be replaced. The identification means 145 can also make it possible to confirm that the container 130 is legitimate and to detect any infringement.

The identification means 145 can be accommodated in the aforementioned third cavity 144 of the container 130 and can be protected by means for closing said third cavity 144, such as an adhesive label. Alternatively, the container can carry a label supporting the identification means, in which case the container does not necessarily need a third cavity, unless the identification means are relatively thick and it is preferable to protect them by accommodating them in this cavity.

In the example shown, the identification means are intended to be detected remotely by reading means 149 carried by the support 110. As can be seen in FIGS. 16 and 17, in the position of mounting a container in the housing of the support, the identification means 145 are positioned substantially facing the reading means 149 but may be separated from one another by a wall of the support such as its rear wall 114, which nevertheless does not impede the identification of the container. Here the reading means 149 are accommodated in an electronic module 127 fixed to the rear of the support. This module 127 is closed and sealed by a removable lid 128. In one particular embodiment of the invention, the identification means 145 include a transponder and the reading means 149 are adapted to read the code of that transponder.

The module 127 can further include means that are connected by electrical cables to the pump 151 in order to control it (FIG. 10).

FIGS. 18 to 25 show another variant embodiment of the device in accordance with the invention.

This variant embodiment differs from that described above notably in that the guide means 224, 241 of the container 230 and of the support 210 are different and the identification means 246a, b and the reading means 247 are different. The device in accordance with the invention essentially includes all the other features described above in so far as they conform to the drawings.

The guide means 224 carried by the support 210 include rectilinear ribs that are substantially vertical and extend over all the height of the support, on its sides. The guide means 241 carried by the container 230 include grooves that are situated on the sides of the container and are substantially complementary to the guide ribs of the support.

The identification means are of mechanical type and here take the form of two additional cavities situated on the rear wall of the container 230, referred to as the fourth cavities 246, configured to cooperate with reading means 247 by contact situated to the rear of the support 210 and accommodated in an electronic module 227 of the aforementioned type. These four cavities 246 are situated on respective opposite sides of the aforementioned third cavity 244. Each has a rectangular general shape and they have different heights, one of them 246a being short and the other one 246b being long. Accordingly, for a given type of container 230 and washer liquid, the short cavity 246a is on a given side (FIGS. 22a and 22b) and for another type of container 230′ and liquid, the short cavity 246a situated on the other side (FIGS. 23a and 23b). The containers 230, 230′ also have swellings of different sizes, as explained above. The reading means 247, which are of switch type, each include at least one pin mobile between a retracted position and a deployed position. When the reading means are situated facing a long cavity 246b, the corresponding pin is in the deployed position and is engaged in that cavity. When the reading means are situated facing a short cavity 246a, the corresponding pin is in the retracted position and bears on the rear wall of the container. When placing the container 230 in the support 210, the reading means 247 are therefore able to identify information relating to the container and to send a corresponding signal to the aforementioned management system.

Thus if a container without these cavities placed on a support, the management system can inhibit the operation of the pump, for example, so as not to deliver the fluid contained in said container to the washer system of the vehicle.

Similarly, the information identified by the identification means can be transmitted to a device for displaying this information in the passenger compartment of the vehicle. FIG. 25 shows a button 300 that can be located in the passenger compartment and that can for example include two indicator lamps 301, 302 each corresponding to one type of washer liquid, i.e. to one type of tank mounted on the support of the washer device. The lamp 301 can indicate that a container containing de-icing liquid is mounted on the support and the lamp 302 can indicate that a container containing anti-insect liquid is mounted on the support, these lamps taking the form of representative diagrams, for example. Each of these lamps can be activated thanks to the information coming from the reading means 247 or the identification means 145 described above and from the management system (the type of fluid contained in the container, the level of fluid in the container, the quantity of fluid already used, the benefit of using the fluid from the container for washing the windshield, taking account of the ambient temperature, for example, etc.). This button 300 may be a control button that may be used to activate the fluid supply device and notably its pump 251.

Regardless of the embodiment, the invention that has just been described finds a preferred application in motor vehicle windshield washer systems.

1. A device for supplying washer fluid, comprising:
at least one washer fluid container; and
a support configured to be fixed to a vehicle and comprising a housing able to receive at least one of said containers, in which the support and/or the container comprise poka yoke means for the positioning of the container.

2. The device as claimed in claim 1, in which said container and said support are configured to allow repeated fitting of said container in and repeated extraction of said container from the housing of said support.

3. The device as claimed in claim 1, in which the support comprises connecting means for connection to one of said containers allowing said container to be placed in communication with a circuit of said fluid.

4. The device as claimed in claim 3, in which the connecting means are configured to allow the opening of one of said containers.

5. The device as claimed in claim 3, in which said support comprises fixing means for a pump.

6. The device as claimed in claim 5, in which the connecting means comprise a pipe intended to connect said container and said pump.

7. The device as claimed in claim 1, in which the support and/or the container further comprise guide means able to allow one of said containers to be mounted in the housing of the support.

8. The device as claimed in claim 7, in which guide means comprise a rectilinear rib or groove.

9. The device as claimed in claim 1, in which said housing of the support has a substantially parallelepipedal shape delimited by at least two lateral walls connected by a wall belonging to the front or rear part of said support.

10. The device as claimed in claim 1, in which the support further comprises locking means intended to hold said container in position.

11. The device as claimed in claim 1, in which said container comprises at least one opening, referred to as first opening, able to collaborate with said connecting means.

12. The device as claimed in claim 11, comprising a second opening able to maintain a pressure, identical to atmospheric pressure, inside said container, said container being rigid.

13. The device as claimed in claim 11, in which said first opening is the only opening of said container designed to be flexible.

14. The device as claimed in claim 11, comprising means for closing at least one of said openings, said closure means preferably being configured to re-close said openings after extraction of said container from said support.

15. The device as claimed in claim 1, in which the container is pre-filled with a washer fluid that is one selected from the group consisting of, a de-icing liquid, a cleaning liquid and an anti-insect liquid.

16. The device as claimed claim 1, in which the container comprises at least two independent compartments), each one of said compartments comprising a first opening, said first openings preferably being opposite one another.

17. The device as claimed in claim 16, in which said container is clipped into said housing.

18. The device as claimed in claim 1, in which the poke yoke means of the support comprise a cutout made in one of the faces of said support so that the poke yoke means of the container may be seen.

19. The device as claimed in claim 1, in which the poke yoke means of the container are a specific shape and/or a label and/or a sticker and/or writing and/or a drawing and/or a color.

20. The device as claimed in claim 1, in which the poke yoke means of the container and of the support are complementary shapes intended to nest one inside the other when the appropriate container is mounted on said support.

21. A vehicle windshield washer system comprising a washer fluid supply device as claimed in claim 1, means for spraying the windshield with said fluid and means for wiping the windshield.
